(19) United States
(12) Patent Application Publication
(10) Pub. No.: US 2012/0140639 A1
(43) Pub. Date: Jun. 7, 2012

(54) CONVERGENCE FOR CONNECTIVITY FAULT MANAGEMENT

(75) Inventors: Ares Shiung-Pin Kao, Taipei City (TW); Vishwas Manral, Sunnyvale, CA (US)

(73) Assignee: IP Infusion Inc., Sunnyvale, CA (US)

(21) Appl. No.: 12/960,364

(22) Filed: Dec. 3, 2010

(51) Int. Cl. H04L 12/26

(52) U.S. Cl. 370/241.1

(57) ABSTRACT

A solution for convergence for connectivity fault management includes, at a device having a network interface, maintaining a continuity state. The continuity state is associated with a Connectivity Fault Management (CFM) Maintenance Association (MA) comprising multiple Maintenance End Points (MEPs) including a first MEP associated with the device. The maintaining includes setting the state to a value indicating continuity of the MA if a converged notification is received from the first MEP. The maintaining also includes setting the state value to a value indicating loss of continuity of the MA if a predetermined number of echo packets sent by the device towards the MEPs other than the first MEP are not received by the device within a predetermined time period.

### TECHNICAL FIELD

The present disclosure relates to convergence for connectivity fault management.

### BACKGROUND

IEEE 802.1ag (“IEEE Standard for Local and Metropolitan Area Networks Virtual Bridged Local Area Networks Amendment 5: Connectivity Fault Management”) is a standard defined by the IEEE (Institute of Electrical and Electronics Engineers). IEEE 802.1ag is largely identical with ITU-T Recommendation Y.1731, which additionally addresses performance management.

IEEE 802.1ag defines protocols and practices for OAM (Operations, Administration, and Maintenance) for paths through IEEE 802.1 bridges and local area networks (LANs). IEEE 802.1 ag defines maintenance domains, their constituent maintenance points, and the managed objects required to create and administer them. IEEE 802.1ag also defines the relationship between maintenance domains and the services offered by virtual local area network (VLAN)-aware bridges and provider bridges. IEEE 802.1ag also describes the protocols and procedures used by maintenance points to maintain and diagnose connectivity faults within a maintenance domain.

Maintenance Domains (MDs) are management space on a network, typically owned and operated by a single entity. Maintenance End Points (MEPs) are Points at the edge of the domain. MEPs define the boundary for the domain. A maintenance association (MA) is a set of MEPs configured with the same maintenance association identifier (MAID) and MD level.

IEEE 802.1ag Ethernet CFM (Connectivity Fault Management) protocols comprise three protocols that work together to help administrators debug Ethernet networks. They are: Continuity Check, Link Trace, and Loop Back.

Continuity Check messages (CCMs) are “heart beat” messages for CFM. The Continuity Check Message provides a means to detect connectivity failures in a MA. CCMs are multicast messages. CCMs are confined to a domain (MD). CCM messages are unidirectional and do not solicit a response. Each MEP transmits a periodic multicast Continuity Check Message inward towards the other MEPs

IEEE 802.1ag specifies that a CCM can be transmitted and received every 3.3 ms for each VLAN to monitor the continuity of each VLAN. A network bridge can typically have up to 4K VLANs. It follows that a bridge may be required to transmit over 12K CCM messages per second and receive 12K×N CCM messages, where N is the average number of remote end-points per VLAN within the network. This requirement creates an overwhelming control plane processing overhead for a network switch and thus presents significant scalability issues.

Accordingly, a need exists for an improved method of verifying point-to-point, point-to-multipoint, and multipoint-to-multipoint Ethernet connectivity among a group of Ethernet endpoints. A further need exists for such a solution that allows OAM protocols such as those defined by IEEE 802.1 ag and ITU-T Y.1731 OAM to utilize this verification method. A further need exists for such a solution that is scalable to support a full range of VLANs available on a network bridge.

### SUMMARY OF THE INVENTION

A solution for convergence for connectivity fault management includes, at a device having a network interface, maintaining a continuity state. The continuity state is associated with a Connectivity Fault Management (CFM) Maintenance Association (MA) comprising multiple Maintenance End Points (MEPs) including a first MEP associated with the device. The maintaining includes setting the state to a value indicating continuity of the MA if a converged notification is received from the first MEP. The maintaining also includes setting the state value to a value indicating loss of continuity of the MA if a predetermined number of echo packets sent by the device towards the MEPs other than the first MEP are not received by the device within a predetermined time period.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates a system for convergence for connectivity fault management in accordance with one embodiment.

FIG. 2 is a block diagram that illustrates a system for convergence for connectivity fault management in accordance with one embodiment.

FIG. 3 is a flow diagram that illustrates a method for convergence for connectivity fault management in accordance with one embodiment.

FIG. 4A is a flow diagram that illustrates a method for convergence for connectivity fault management from the perspective of a beacon node sending a point-to-point echo packet towards a non-beacon node in accordance with one embodiment.

FIG. 4B is a flow diagram that illustrates a method for convergence for connectivity fault management from the perspective of a non-beacon node receiving a point-to-point echo packet in accordance with one embodiment.

FIG. 5A is a flow diagram that illustrates a method for convergence for connectivity fault management from the perspective of a beacon node sending a point-to-multipoint echo packet towards non-beacon nodes in accordance with one embodiment.

FIG. 5B is a flow diagram that illustrates a method for convergence for connectivity fault management from the perspective of a non-beacon node receiving a point-to-multipoint echo packet in accordance with one embodiment.

FIG. 6A is a flow diagram that illustrates a method for convergence for connectivity fault management from the perspective of a beacon node sending a multipoint-to-multipoint echo packet towards non-beacon nodes in accordance with one embodiment.

FIG. 6B is a flow diagram that illustrates a method for convergence for connectivity fault management from the perspective of a non-beacon node receiving a multipoint-to-multipoint echo packet in accordance with one embodiment.

FIG. 7 is a block diagram of a computer system suitable for implementing aspects of the present disclosure.

### DETAILED DESCRIPTION

Embodiments of the present invention are described herein in the context of convergence for connectivity fault management. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “network” includes any manner of data network, including, but not limited to, networks sometimes (but not always and sometimes overlappingly) called or exemplified by local area networks (LANs), wide area networks (WANs), metro area networks (MANs), storage area networks (SANs), residential networks, corporate networks, inter-networks, the Internet, the World Wide Web, cable television systems, telephone systems, wireless telecommunications systems, fiber optic networks, token ring networks, Ethernet networks, Fibre Channel networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “distributed” describes a digital information system dispersed over multiple computers and not centralized at a single location.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

In the context of the present invention, the term “network interface” describes the means by which users access a network for the purposes of communicating across it or retrieving information from it.

In the context of the present invention, the term “system” describes any computer information and/or control device, devices or network of devices, of hardware and/or software, comprising processor means, data storage means, program means, and/or user interface means, which is adapted to communicate with the embodiments of the present invention, via one or more data networks or connections, and is adapted for use in conjunction with the embodiments of the present invention.

In the context of the present invention, the term “switch” describes any network equipment with the capability of forwarding data bits from an ingress port to an egress port. Note that “switch” is not used in a limited sense to refer to FC switches. A “switch” can be an FC switch, Ethernet switch, TRILL routing bridge (RBridge), IP router, or any type of data forwarder using open-standard or proprietary protocols.

The terms “frame” or “packet” describe a group of bits that can be transported together across a network. “Frame” should not be interpreted as limiting embodiments of the present invention to Layer 2 networks. “Packet” should not be interpreted as limiting embodiments of the present invention to Layer 3 networks. “Frame” or “packet” can be replaced by other terminologies referring to a group of bits, such as “cell” or “datagram.”

It should be noted that the convergence for connectivity fault management system is illustrated and discussed herein as having various modules which perform particular functions and interact with one another. It should be understood that these modules are merely segregated based on their function for the sake of description and represent computer hardware and/or executable software code which is stored on a computer-readable medium for execution by appropriate computing hardware. The various functions of the different modules and units can be combined or segregated as hardware and/or software stored on a computer-readable medium as above as modules in any manner, and can be used separately or in combination.

In example embodiments of the present invention, a continuity verification service is provided to an Ethernet OAM module, allowing augmentation of the Ethernet OAM continuity check messaging model to improve scalability of the continuity check function. When coupled with Ethernet OAM CC, Ethernet OAM CC may be configured to execute at a relatively low rate while the continuity verification service described herein may be configured to execute at a relatively high rate to maintain a desired continuity fault detection time while minimizing control plane overhead.

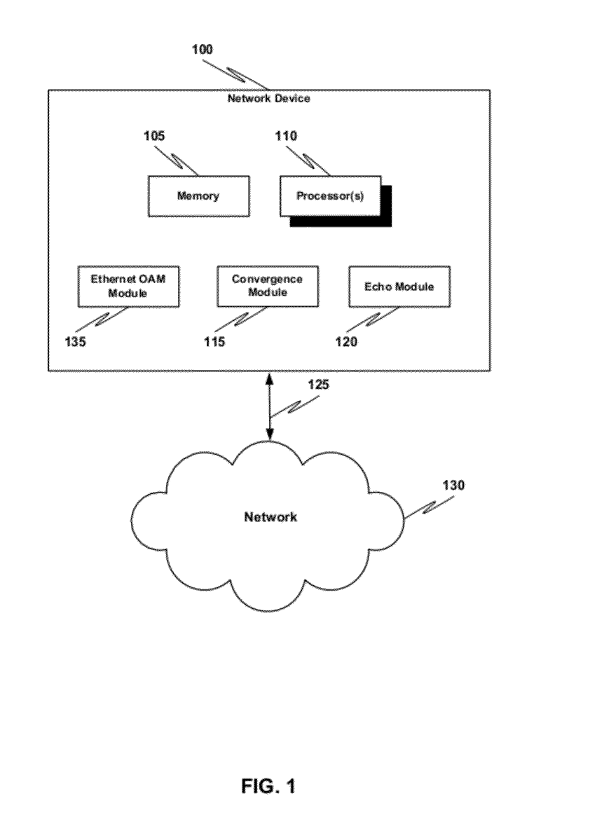

FIG. 1 is a block diagram that illustrates a system for convergence for connectivity fault management in accordance with one embodiment. As shown in FIG. 1, network device 100 is communicably coupled (125) to network 130. Network device 100 comprises a memory 105, one or more processors 110, an Ethernet OAM module 135, a convergence module 115, and an echo module 120. The one or more processors 110 are configured to maintain a continuity state that is associated with a Connectivity Fault Management (CFM) Maintenance Association (MA) comprising multiple Maintenance End Points (MEPs) including a local MEP associated with the device 100. The continuity state may be stored in memory 105. The one or more processors 110 are configured to maintain the continuity state by setting the state to a value indicating continuity of the MA if a converged notification is received from the first MEP. The one or more processors 110 are further configured to maintain the continuity state by setting the state to a value indicating loss of continuity of the MA if a predetermined number of echo packets sent by the device 100 towards the MEPs other than the first MEP are not received by the device 100 within a predetermined time period.

According to one embodiment, echo module 120 and convergence module 115 are combined into a single module. According to another embodiment, all or part of convergence module 115 and echo module 120 are integrated within Ethernet OAM module 135.

According to one embodiment, the one or more processors 110 are further configured to set the state to a value indicating loss of continuity if a nonconverged notification is received, or if a notification that the first MEP has been disabled is received.

According to one embodiment, the one or more processors 110 are further configured to send the state towards the first MEP. Ethernet OAM module 135 may use the state forwarded by the one or more processors 110 to update its continuity status.

According to one embodiment, Ethernet OAM module 135 is further configured to perform continuity checking at a relatively low frequency. The one or more processors 110 are further configured to perform the maintaining (continuity service) at a relatively high frequency. For example, continuity checking by Ethernet OAM module 135 may be configured to execute at 5-second intervals, and the maintaining may be configured to execute at 3.3 ms intervals.

According to one embodiment, upon receiving from convergence module 115 an indication of loss of continuity, Ethernet OAM module 135 behaves as if it had lost CCM frames for a remote MEP within the MA for a predetermined number of consecutive CCM frame intervals. According to one embodiment, the predetermined number is three. Similarly, according to one embodiment, upon receiving from convergence module 115 an indication of continuity, Ethernet OAM module 135 behaves as if it has just started to receive CCM frames from the disconnected remote MEP again.

According to one embodiment, the one or more processors 110 are further configured to, if the converged notification is received, receive a value indicating a quantity of remote MEPs in the MA, and possibly physical addresses associated with the remote MEPs. The physical addresses may be, for example, MAC addresses. The physical addresses may be used to maintain per-node continuity status.

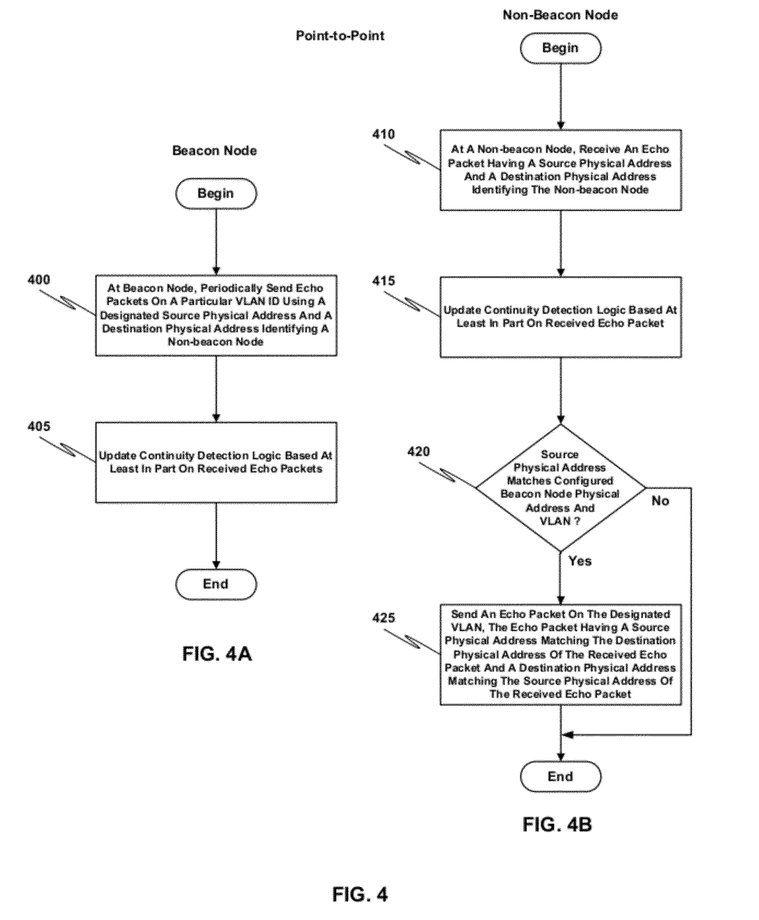

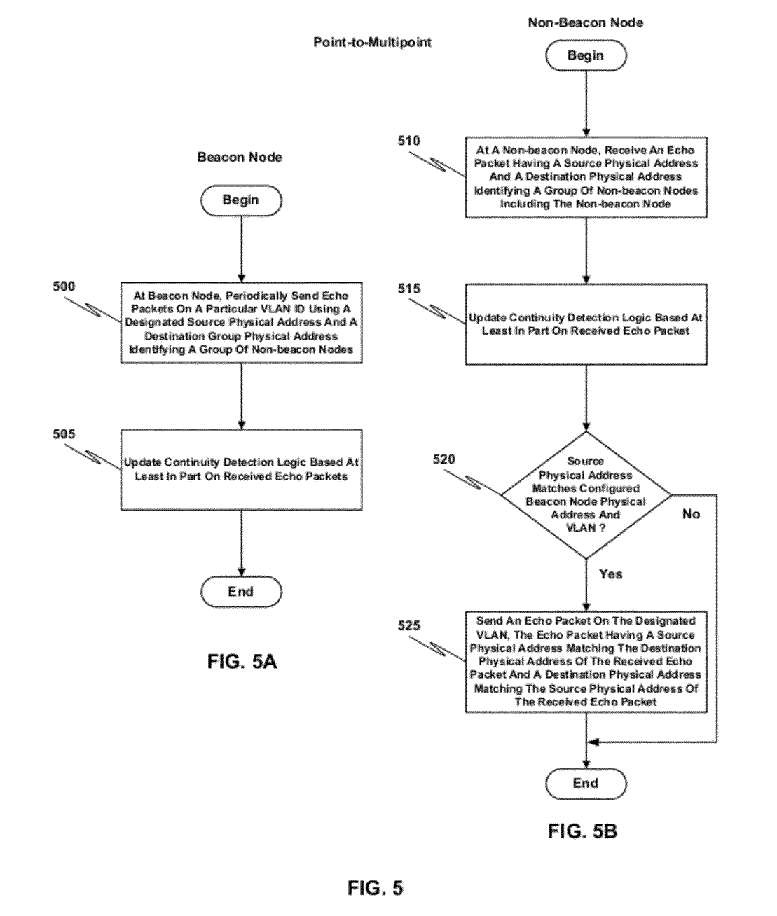

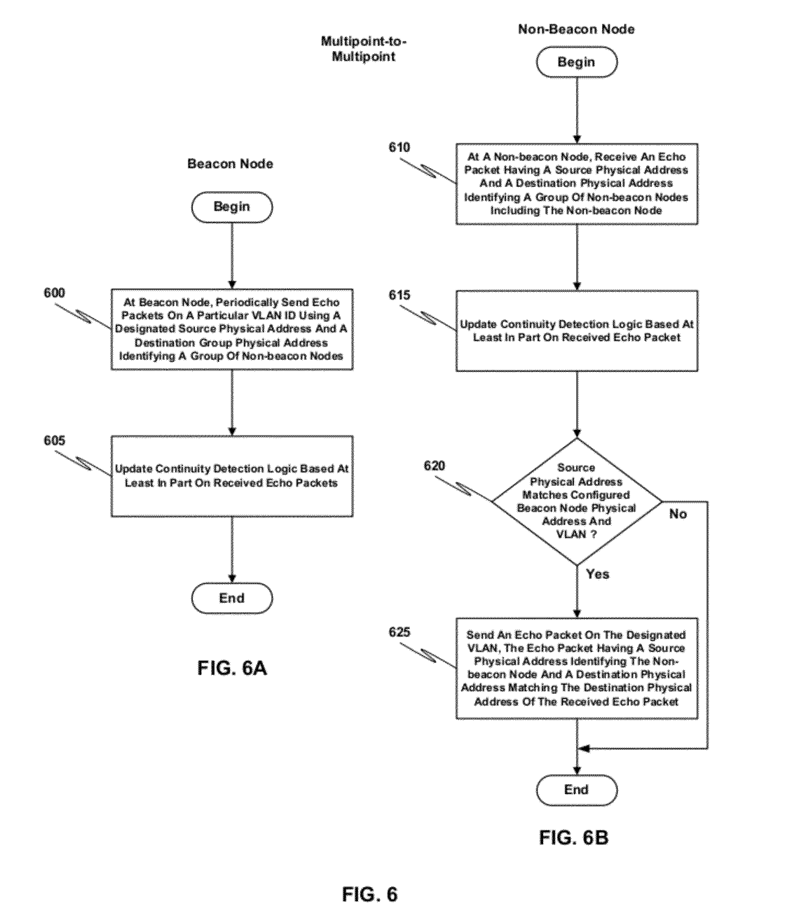

According to one embodiment, the echo packets sent by the device 100 comprise point-to-point echo packets. This is described in more detail below, with reference to FIGS. 4A and 4B. According to another embodiment, the echo packets sent by the device 100 comprise point-to-multipoint echo packets. This is described in more detail below, with reference to FIGS. 5A and 5B. According to another embodiment, the echo packets sent by the device 100 comprise multipoint-to-multipoint echo packets. This is described in more detail below, with reference to FIGS. 6A and 6B.

According to one embodiment, the device 100 is configured as one or more of a switch, a bridge, a router, a gateway, and an access device. Device 100 may also be configured as other types of network devices.

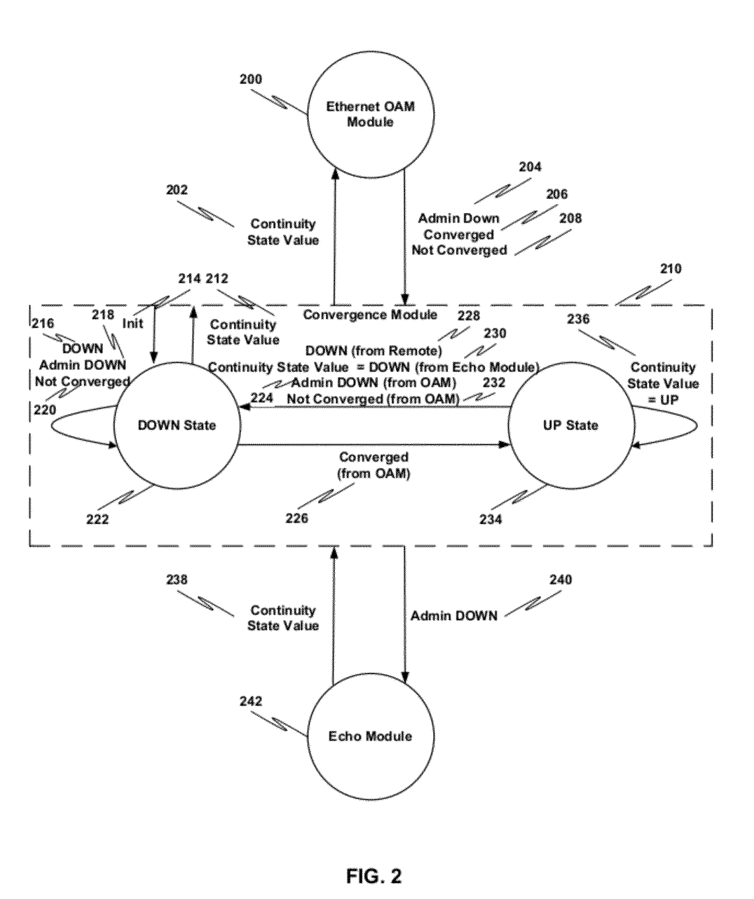

FIG. 2 is a block diagram that illustrates a system for convergence for connectivity fault management in accordance with one embodiment. As shown in FIG. 2, upon initialization 214, convergence module 210 is in the “DOWN” state 222. When a converged notification 206 is received from Ethernet OAM module 200, the state transitions to the “UP” state 234 and the echo module 242 is engaged. Upon receiving from echo module 242 a continuity state value 238 indicating a loss of continuity, the state of convergence module 210 transitions 230 to the “DOWN” state 234. While in the “DOWN” state 222, if a converged notification 206 is received from Ethernet OAM module 200, then convergence module 210 transitions 226 to the “UP” state.

While convergence module 210 is in the “DOWN” state 222, continuity state values 238 received from echo module 242 will cause convergence module 210 to remain in the “DOWN” state 222, and the continuity state value 238 is passed 202 to the Ethernet OAM module 200. Once Ethernet OAM module 200 re-converges on the MA, Ethernet OAM module 200 sends a converged notification 206 to convergence module 210, driving convergence module 210 to the “UP” state 234.

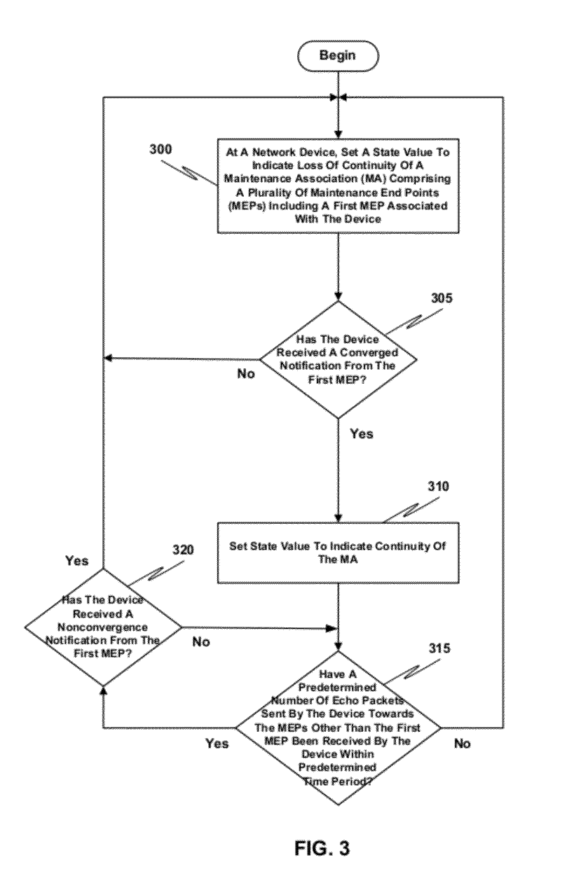

FIG. 3 is a flow diagram that illustrates a method for convergence for connectivity fault management in accordance with one embodiment. The processes illustrated in FIG. 3 may be implemented in hardware, software, firmware, or a combination thereof. For example, the processes illustrated in FIG. 3 may be implemented by network device 100 of FIG. 1. At 300, at a network device 100, a state value is set to indicate loss of continuity of a MA comprising multiple MEPs including a first MEP 200 associated with the device 100. At 305, a determination is made regarding whether the device 100 has received a converged notification 226 from the first MEP 200. If a converged notification has been received from the first MEP 200, at 310 the state value is set to indicate continuity of the MA. If at 305 the device 100 has not received a converged notification from the first MEP 200, at 320 a determination is made regarding whether the device 100 has received a nonconvergence notification 232 from the first MEP. If at 320 the device 100 has received a nonconvergence notification 232 from the first MEP 200, processing continues at 300. If at 320 the device 100 has not received a nonconvergence notification 232 from the first MEP 200, at 315 a determination is made regarding whether a predetermined number of echo packets sent by the device 100 towards the MEPs other than the first MEP 200 have been received by the device 100 within a predetermined time period. If at 315 a predetermined number of echo packets sent by the device 100 towards the MEPs other than the first MEP 200 have been received by the device 100 within the predetermined time period, processing continues at 320. If at 315 a predetermined number of echo packets sent by the device 100 towards the MEPs other than the first MEP 200 have not been received by the device 100 within the predetermined time period, processing continues at 300.

### Echo Module

According to one embodiment, echo module 120 is configured to off-load processing overhead of Ethernet OAM 200 Continuity Check processing. For each Ethernet OAM MA (per VLAN or per Service Instance) there is one and only one MEP designated as a “beacon” entity for convergence module 115. All other MEPs in the MA are considered “non-beacon” entities.

The “beacon” entity is configured in active mode while all “non-beacon” entities are configured in passive mode. That is, a beacon entity configured in active mode sends out echo packets periodically. Beacon entities configured in passive mode do not actively send out echo packets.

When a Beacon entity receives an echo packet, it updates its continuity state value in convergence module 210. The convergence module 115 is configured to use this information to deduce whether loss of continuity should be intimated to its parent session which will in turn notify its Ethernet OAM application client 200.

A non-beacon entity is configured to, it receives an echo packet, modify the echo packet and loop back the echo packet. Depending on the connection model (i.e., point-to-point, point-to-multipoint, multipoint-to-multipoint), the echo packet will undergo different packet modification rules before it is looped back. According to one embodiment, the returned echo packet is sent on a different VLAN ID (VID). This is described in more detail below with reference to FIGS. 4A-6B.

### Continuity Detection Cycle

According to one embodiment, a continuity detection cycle is defined as a sequence of N echo packets sent with a time interval Tms (microsecond) between each echo packet. Therefore, a detection cycle is N*T microseconds. For example, if N=3 and T=3.3, then a detection cycle is calculated as 9.9 ms. In other words, for every 9.9 ms, 3 echo packets should be received.

### Class of Continuity Detection Logic

### MA Level

According to one embodiment, convergence module 115 attempts to detect loss of continuity at the MA level, without necessarily identifying exactly which entity's connectivity is lost.

This class of detection logic has the potential to achieve minimum resource overhead. For example, a MA has M non-beacon MEP and a (N*T) detection cycle, a beacon node should expect to receive a total of (M*N) echo packets every detection cycle. If we define a “MA continuity threshold” CT to be the maximum number of lost echo packet before the signal failure condition is declared on a MA and X is the actual number of echo packets a beacon node received then it follows that—

for each detection cycle {

If ((M*N) − X) >= CT) then

Continuity = False

else

Continuity = True

}

By adjusting the threshold value, a MA fault tolerance factor can be defined.

### Node Level

According to one embodiment, the one or more processors 110 are further configured to set the state to a value indicating loss of continuity if a predetermined number of echo packets sent by the device towards MA or a particular one of the MEPs other than the first MEP 200 are not received by the device within a predetermined time period.

For this class of detection, convergence module 210 attempts to detect loss of continuity to any entity which is a member of the MA.

This class of detection logic stores information such as list of physical addresses for every MEP in a MA. Convergence module 115 is configured to use this additional information to identify which non-beacon MEP has lost continuity. Let X(MEP-ID) represent the number of echo packets received within a detection cycle from non-beacon MEP with MEP-ID then the following detection logic can be derived—

for each detection cycle {

for (i=1, i<=M; i++) {

If (N − X(MEP(i))) >= CT) then

Continuity = FALSE

else

Continuity = TRUE

}

}

### Echo Packet Distribution

FIGS. 4A-6B illustrate echo packet distribution within an Ethernet network in accordance with embodiments of the present invention. FIGS. 4A and 4B illustrate echo packet distribution in accordance with a point-to-point model in accordance with an embodiment. FIGS. 5A and 5B illustrate echo packet distribution in accordance with a point-to-multipoint model in accordance with an embodiment. FIGS. 6A and 6B illustrate echo packet distribution in accordance with a multipoint-to-multipoint model in accordance with an embodiment. According to one embodiment, the point-to-point and point-to-multipoint connection model complies with standard specification IEEE 802.1Qay (“Provider Backbone Bridge Traffic Engineering”).

### Point-to-Point Echo Packets

When a network device configured as a beacon node (“device A”) initiates an echo packet to a network device configured as a non-beacon node (“device B”), device B puts a device B's reserved physical address in the source physical address field and a device B reserved physical address in the destination address field. Device A also fills the VLAN-ID with a specific value and sends the Ethernet frame to device B.

When device B replies an echo packet back to device A, device B swaps the source and destination fields in the received echo packet and also fills the VLAN-ID with a specific value and sends the Ethernet frame back to device A. The VLAN-ID can be the same VLAN-ID as in the received echo packet, or it can be a different value.

According to one embodiment, an echo frame is identified by a reserved physical addresses, for example a unicast or group physical address. According to another embodiment, an echo frame is identified by a reserved Ethertype in the length/type field.

FIG. 4A is a flow diagram that illustrates a method for convergence for connectivity fault management from the perspective of a beacon node sending a point-to-point echo packet towards a non-beacon node in accordance with one embodiment. The processes illustrated in FIG. 4A may be implemented in hardware, software, firmware, or a combination thereof. For example, the processes illustrated in FIG. 4A may be implemented by network device 100 of FIG. 1. At 400, at a device 100 configured as a beacon node, echo packets are sent periodically on a particular VLAN ID using a designated source physical address and a destination physical address identifying a non-beacon node. At 405, continuity state value 212 of convergence module 210 on the device 100 is updated based at least in part on received echo packets. The convergence module 210 may in turn send the continuity state value 202 to Ethernet OAM module 200.

FIG. 4B is a flow diagram that illustrates a method for convergence for connectivity fault management from the perspective of a non-beacon node receiving a point-to-point echo packet in accordance with one embodiment. The processes illustrated in FIG. 4B may be implemented in hardware, software, firmware, or a combination thereof. For example, the processes illustrated in FIG. 4B may be implemented by network device 100 of FIG. 1. At 410, at a device 100 configured as a non-beacon node, an echo packet having a source physical address and a destination physical address identifying the non-beacon node is received. At 415, continuity state value 212 of convergence module 210 on the device 100 is updated based at least in part on the received echo packet. The convergence module 210 may in turn send the continuity state value 202 to Ethernet OAM module 200. At 420, a determination is made regarding whether the source physical address matches the configured beacon node physical address and VLAN. If at 420 the source physical address matches the configured beacon node physical address and VLAN, at 425 an echo packet is sent on the designated VLAN. The echo packet has a source physical address that matches the destination physical address of the received echo packet, and a destination physical address matching the source physical address of the received echo packet.

According to one embodiment, device configured as a beacon node and devices configured as non-beacon nodes encapsulate packets according to a standard. According to one embodiment, the standard is IEEE 802.1Q. An Ethernet frame according to IEEE 802.1 Q is shown in Table 1 below.

TABLE 1

| | | | | | | | | | |
|---|---|---|---|---|---|---|---|---|---|
| Preamble | Start | Dest. | Source | Length/Type = | Tag | Length/ | MAC Client | Pad | Frame |
| (7-bytes) | Frame | MAC | MAC | 802.1Q | Control | Type | Data | (0-p bytes) | Check |
| | Delimiter | Address | Address | Tag Type | Information | (2-bytes) | (0-n bytes) | | Sequence |
| | (1-byte) | (6-bytes) | (6-bytes) | (2-byte) | (2-bytes) | | | | (4-bytes) |

According to another embodiment, packets are encapsulated according to IEEE 802.1ad Q-in-Q frame format. According to another embodiment, packets are encapsulated according to IEEE 802.1ah MAC-in-MAC frame format.

According to one embodiment, echo module 242 uses the outer-most VLAN tag of an Ethernet frame format. For example, echo module 242 uses the C-tag in the case of an IEEE 802.1Q frame. As a further example, echo module 242 uses the S-tag in the case of an IEEE 802.1ad. As a further example, echo module uses the B-tag in the case of an IEEE 802.1ah frame.

### Point-to-Multipoint Echo Packets

FIG. 5A is a flow diagram that illustrates a method for convergence for connectivity fault management from the perspective of a beacon node sending a point-to-multipoint echo packet towards non-beacon nodes in accordance with one embodiment. The processes illustrated in FIG. 5A may be implemented in hardware, software, firmware, or a combination thereof. For example, the processes illustrated in FIG. 5A may be implemented by network device 100 of FIG. 1. At 500, at a device 100 configured as a beacon node, echo packets are sent periodically on a particular VLAN ID using a designated source physical address and a destination group physical address identifying a group of non-beacon nodes. At 505, continuity state value 212 of convergence module 210 on the device 100 is updated based at least in part on received echo packets. The convergence module 210 may in turn send the continuity state value 202 to Ethernet OAM module 200.

FIG. 5B is a flow diagram that illustrates a method for convergence for connectivity fault management from the perspective of a non-beacon node receiving a point-to-multipoint echo packet in accordance with one embodiment. The processes illustrated in FIG. 5B may be implemented in hardware, software, firmware, or a combination thereof. For example, the processes illustrated in FIG. 5B may be implemented by network device 100 of FIG. 1. At 510, at a device 100 configured as a non-beacon node, an echo packet having a source physical address and a destination physical address identifying a group of non-beacon nodes including the non-beacon node is received. At 515, continuity state value 212 of convergence module 210 on the device 100 is updated based at least in part on the received echo packet. The convergence module 210 may in turn send the continuity state value 202 to Ethernet OAM module 200. At 520, a determination is made regarding whether the source physical address matches the configured beacon node physical address and VLAN. If at 520 the source physical address matches the configured beacon node physical address and VLAN, at 525 an echo packet is sent on the designated VLAN. The echo packet has a source physical address that matches the destination physical address of the received echo packet, and a destination physical address matching the source physical address of the received echo packet. This implies that the looped back echo packet will be received by the beacon node only on a specific VLAN.

FIG. 6A is a flow diagram that illustrates a method for convergence for connectivity fault management from the perspective of a beacon node sending a multipoint-to-multipoint echo packet towards non-beacon nodes in accordance with one embodiment. The processes illustrated in FIG. 6A may be implemented in hardware, software, firmware, or a combination thereof. For example, the processes illustrated in FIG. 6A may be implemented by network device 100 of FIG. 1. At 600, at a device 100 configured as a beacon node, echo packets are sent periodically on a particular VLAN ID using a designated source physical address and a destination physical address identifying a group of non-beacon nodes. At 605, continuity state value 212 of convergence module 210 on the device 100 is updated based at least in part on received echo packets. The convergence module 210 may in turn send the continuity state value 202 to Ethernet OAM module 200.

FIG. 6B is a flow diagram that illustrates a method for convergence for connectivity fault management from the perspective of a non-beacon node receiving a multipoint-to-multipoint echo packet in accordance with one embodiment. The processes illustrated in FIG. 6B may be implemented in hardware, software, firmware, or a combination thereof. For example, the processes illustrated in FIG. 6B may be implemented by network device 100 of FIG. 1. At 610, at a device 100 configured as a non-beacon node, an echo packet having a source physical address and a destination physical address identifying a group of non-beacon nodes including the non-beacon node is received. At 615, continuity state value 212 of convergence module 210 on the device 100 is updated based at least in part on the received echo packet. The convergence module 210 may in turn send the continuity state value 202 to Ethernet OAM module 200. At 620, a determination is made regarding whether the source physical address matches the configured beacon node physical address and VLAN. If at 620 the source physical address matches the configured beacon node physical address and VLAN, at 625 an echo packet is sent on the designated VLAN. The echo packet has a source physical address that identifies the non-beacon node, and a destination physical address matching the destination physical address of the received echo packet. This implies that the looped back echo packet will be received by the beacon node and all other non-beacon node on the specified VLAN.

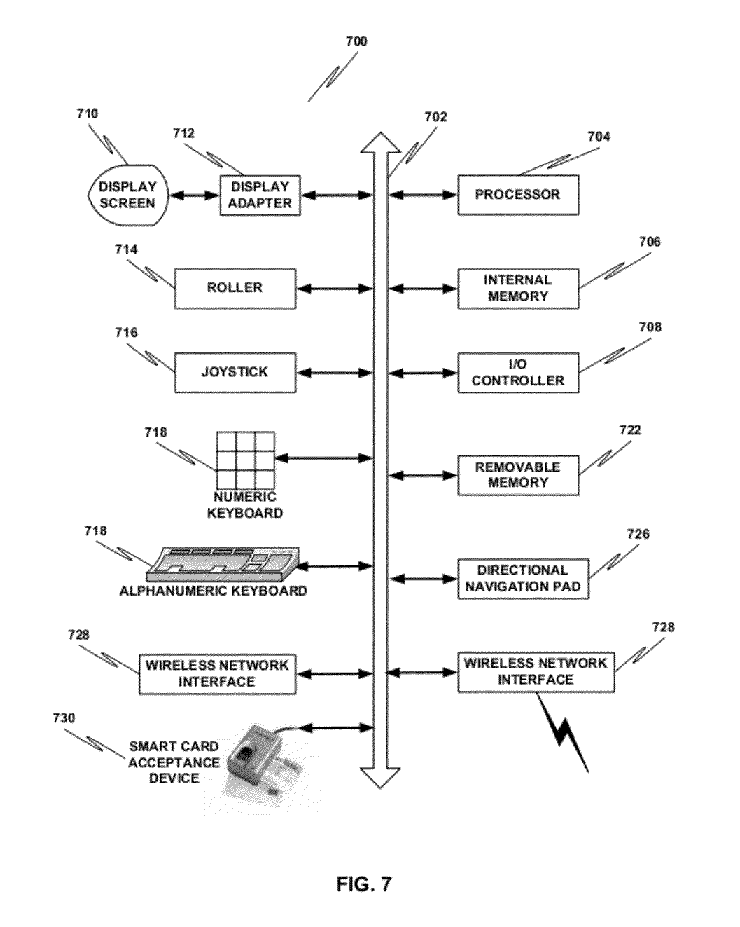

FIG. 7 depicts a block diagram of a computer system 700 suitable for implementing aspects of the present disclosure. As shown in FIG. 7, system 700 includes a bus 702 which interconnects major subsystems such as a processor 704, an internal memory 706 (such as a RAM), an input/output (I/O) controller 708, a removable memory (such as a memory card) 722, an external device such as a display screen 710 via display adapter 712, a roller-type input device 714, a joystick 716, a numeric keyboard 718, an alphanumeric keyboard 718, directional navigation pad 726, smart card acceptance device 730, and a wireless interface 720. Many other devices can be connected. Wireless network interface 720, wired network interface 728, or both, may be used to interface to a local or wide area network (such as the Internet) using any network interface system known to those skilled in the art.

Many other devices or subsystems (not shown) may be connected in a similar manner. Also, it is not necessary for all of the devices shown in FIG. 7 to be present to practice the present invention. Furthermore, the devices and subsystems may be interconnected in different ways from that shown in FIG. 7. Code to implement the present invention may be operably disposed in internal memory 706 or stored on storage media such as removable memory 722, a floppy disk, a thumb drive, a CompactFlash® storage device, a DVD-R (“Digital Versatile Disc” or “Digital Video Disc” recordable), a DVD-ROM (“Digital Versatile Disc” or “Digital Video Disc” read-only memory), a CD-R (Compact Disc-Recordable), or a CD-ROM (Compact Disc read-only memory).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method comprising:
at a device having a network interface, maintaining a continuity state, the continuity state associated with a Connectivity Fault Management (CFM) Maintenance Association (MA) comprising a plurality of Maintenance End Points (MEPs) including a first MEP associated with the device, the maintaining comprising setting the state to a value indicating:
continuity of the MA if a converged notification is received from the first MEP; and
loss of continuity of the MA if a predetermined number of echo packets sent by the device towards the MEPs other than the first MEP are not received by the device within a predetermined time period.

2. The method of claim 1, further comprising setting the state to a value indicating a loss of continuity if:
a nonconverged notification is received; or
a notification that the first MEP has been disabled is received.

3. The method of claim 1, further comprising sending the state towards the first MEP.

4. The method of claim 1, further comprising:
performing continuity checking by the CFM MA at a relatively low frequency; and
performing the maintaining at a relatively high frequency.

5. The method of claim 1, further comprising:
if the converged notification is received, receiving one or more of:
a value indicating a quantity of remote MEPs in the MA; and
physical addresses associated with the remote MEPs.

6. The method of claim 1 wherein setting the state to a value indicating loss of continuity further comprises setting the state to a value indicating loss of continuity if a predetermined number of echo packets sent by the device towards a MA or a particular one of the MEPs other than the first MEP are not received by the device within a predetermined time period.

7. The method of claim 1 wherein the echo packets sent by the device comprise point-to-point echo packets.

8. The method of claim 1 wherein the echo packets sent by the device comprise point-to-multipoint echo packets.

9. The method of claim 1 wherein the echo packets sent by the device comprise multipoint-to-multipoint echo packets.

10. The method of claim 1 wherein the device is configured as one or more of:
a switch;
a bridge;
a router;
a gateway; and
an access device.

11. The method of claim 1 wherein
the echo packets are sent by the device on a first virtual local area network ID (VID); and
the echo packets received by the device are received on a second VID that is different from the first VID.

12. An apparatus comprising:
a memory;
a network interface; and
one or more processors configured to:
maintain a continuity state, the continuity state associated with a Connectivity Fault Management (CFM) Maintenance Association (MA) comprising a plurality of Maintenance End Points (MEPs) including a first MEP associated with the apparatus, the maintaining comprising setting the state to a value indicating: continuity of the MA if a converged notification is received from the first MEP; and
loss of continuity of the MA if a predetermined number of echo packets sent by the apparatus towards the MEPs other than the first MEP are not received by the apparatus within a predetermined time period.

13. The apparatus of claim 12 wherein the one or more processors are further configured to set the state to a value indicating a loss of continuity if:
a nonconverged notification is received; or
a notification that the first MEP has been disabled is received.

14. The apparatus of claim 12 wherein the one or more processors are further configured to send the state towards the first MEP.

15. The apparatus of claim 12 wherein the one or more processors are further configured to:
perform continuity checking by the CFM MA at a relatively low frequency; and
perform the maintaining at a relatively high frequency.

16. The apparatus of claim 12 wherein the one or more processors are further configured to:
if the converged notification is received, receive one or more of:
a value indicating a quantity of remote MEPs in the MA; and
physical addresses associated with the remote MEPs.

17. The apparatus of claim 12 wherein the one or more processors are further configured to set the state to a value indicating loss of continuity if a predetermined number of echo packets sent by the apparatus towards a MA or a particular one of the MEPs other than the first MEP are not received by the apparatus within a predetermined time period.

18. The apparatus of claim 12 wherein the echo packets sent by the apparatus comprise point-to-point echo packets.

19. The apparatus of claim 12 wherein the echo packets sent by the apparatus comprise point-to-multipoint echo packets.

20. The apparatus of claim 12 wherein the echo packets sent by the apparatus comprise multipoint-to-multipoint echo packets.

21. The apparatus of claim 12 wherein the apparatus is configured as one or more of:
a switch;
a bridge;
a router;
a gateway; and
an access device.

22. The apparatus of claim 12 wherein the one or more processors are further configured to:
send the echo packets on a first virtual local area network ID (VID); and
receive the echo packets on a second VID that is different from the first VID.

23. An apparatus comprising:
a memory;
a network interface; and
means for, at a device having a network interface, maintaining a continuity state, the continuity state associated with a Connectivity Fault Management (CFM) Maintenance Association (MA) comprising a plurality of Maintenance End Points (MEPs) including a first MEP associated with the device, the maintaining comprising setting the state to a value indicating:
continuity of the MA if a converged notification is received from the first MEP; and
loss of continuity of the MA if a predetermined number of echo packets sent by the device towards the MEPs other than the first MEP are not received by the device within a predetermined time period.

24. A nontransitory program storage device readable by a machine, embodying a program of instructions executable by the machine to perform a method, the method comprising:
at a device having a network interface, maintaining a continuity state, the continuity state associated with a Connectivity Fault Management (CFM) Maintenance Association (MA) comprising a plurality of Maintenance End Points (MEPs) including a first MEP associated with the device, the maintaining comprising setting the state to a value indicating:
continuity of the MA if a converged notification is received from the first MEP; and
loss of continuity of the MA if a predetermined number of echo packets sent by the device towards the MEPs other than the first MEP are not received by the device within a predetermined time period.
